(19) United States
(12) Patent Application Publication
(10) Pub. No.: US 2009/0049876 A1
(43) Pub. Date: Feb. 26, 2009

(54) SECURITY APPARATUS WITH STABILIZING ELEMENT

(75) Inventors: Ryan White, San Francisco, CA (US); John Hung, Vancouver, B.C. (CA); Guillermo Andres, Pleasanton, CA (US); Robert Mahaffey, Vancouver, B.C. (CA)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: ACCO Brands USA LLC, Lincolnshire, IL (US)

(21) Appl. No.: 12/192,516

(22) Filed: Aug. 15, 2008

Related U.S. Application Data
(60) Provisional application No. 60/957,230, filed on Aug. 22, 2007.

(51) Int. Cl. E05B 65/48

(52) U.S. Cl. 70/58

(57) ABSTRACT

A security apparatus for use with a portable electronic device with an aperture. The security apparatus includes a head including a housing, an engagement element extending from the housing, a first stabilizing element extending from the housing, and can have a second stabilizing element extending from the housing. The first stabilizing element extends out of the housing a first length and the second stabilizing element extends out of the housing a second length. The first and second lengths are different, and a security device is coupled to the head

### CROSS-REFERENCES TO RELATED APPLICATIONS

This patent application is a non-provisional of and claims priority to U.S. provisional patent application No. 60/957,230, filed on Aug. 22, 2007, which is herein incorporated by reference in its entirety for all purposes.

### BACKGROUND

A number of physical security apparatuses are known. One type of physical security apparatus comprises an L-leg and a bolt. The L-leg extends out from a housing that is part of a physical security apparatus and is stationary. The bolt may extend or retract relative to the L-leg. When the bolt is in an extended position, the bolt and the L-leg can be secured to a security slot in a portable electronic device. When the bolt is in a retracted position, the L-leg can be removed from the security slot and the physical security apparatus may be separated from the portable electronic device.

In this type of security apparatus, problems with engaging with only one side of the security slot include: (1) obtaining adequate engagement with the security slot to prevent easy disengagement when a force/torque is applied to a “locked” mechanism; (2) obtaining adequate security slot compatibility with existing security slots on existing portable electronic devices; and (3) ease of use; prior art designs can be difficult to use.

Embodiments of the invention address these and other problems, individually and collectively.

### BRIEF SUMMARY

Embodiments of the invention are directed to physical security apparatuses, as well as systems and methods for using such physical security apparatuses.

One embodiment of the invention is directed to a security apparatus for use with an aperture in a portable electronic device. The security apparatus includes a head having a housing, an engagement element extending from the housing, a first stabilizing element that extends from the housing, and a second stabilizing element that extends from the housing. The first stabilizing element extends out of the housing a first length and the second stabilizing element extends out of the housing a second length. The first and second lengths are different, and a security device is coupled to the head.

Another embodiment of the invention is directed to a system comprising a portable electronic device comprising an aperture, and the above-described security apparatus secured to the portable electronic device via the aperture

Another embodiment of the invention is directed to a method of using the above-described security apparatus including inserting the engagement element into the aperture, and moving the engagement element, thereby securing the security apparatus to the portable electronic device via the aperture.

Another embodiment of the invention is directed to a method for using the above-described security apparatus with a portable electronic device comprising an aperture. The method comprises inserting the engagement element into the aperture, and moving at least one of the first and second stabilizing elements, thereby securing the security apparatus to the portable electronic device via the aperture.

Another embodiment of the invention is directed to a method. The method comprises inserting an engagement element and a stabilizing element into the aperture, wherein the engagement element comprises a distal portion and a proximate portion, and further wherein the engagement element and the stabilizing element are coupled to the head of a security apparatus, rotating the engagement element with respect to the stabilizing element, such that the engagement element couples with a single side of the aperture, and coupling a security device to an object other than the portable consumer device, wherein the security device is attached to the head of the security apparatus.

These and other embodiments of the invention are described in further detail below with reference to the Figures and the Detailed Description.

### BRIEF DESCRIPTION OF THE DRAWINGS

FIG. 1 shows a system according to an embodiment of the invention.

FIG. 2 shows a physical security apparatus in a locked configuration. An outline of a housing portion is shown by dotted lines.

FIG. 3 shows a physical security apparatus in an unlocked configuration. An outline of a housing portion is shown by dotted lines.

FIG. 4 shows an exploded view of a physical security apparatus according to an embodiment of the invention.

FIG. 5 shows top and side cross sectional views of a physical security apparatus according to an embodiment of the invention.

In the Figures, like numerals designate like elements, and the descriptions of like elements may not be repeated in some instances.

### DETAILED DESCRIPTION

Embodiments of the invention are directed to security apparatuses, methods for using security apparatuses, and systems using such security apparatuses. The security apparatuses can be used to prevent or deter the theft of portable electronic devices.

The portable electronic device to be secured may comprise an aperture, and the aperture may be a through aperture or a blind aperture. The aperture may be formed in a housing associated with the portable electronic device. Alternatively or additionally, the portable electronic device may include a lock interface member, and the lock interface member may comprise the aperture. The lock interface member may be used to enhance security and may improve the strength of the coupling between the portable electronic device and the security apparatus. The lock interface member may be an attachment that may be attached to the housing of the portable electronic device, or it may be integrally formed in the housing. For example, in some embodiments, the lock interface member may be operatively or physically coupled to the chassis of the portable electronic device and/or may be operatively or electrically coupled to some electrical component in the portable electronic device. Exemplary lock interface members are described in U.S. Provisional Patent Application No. 60/853,888, filed on Oct. 23, 2006, 60/909,867, filed on Apr. 3, 2007, and 60/940,318, filed on May 25, 2007, as well as PCT Application Nos. PCT/US07/76884, PCT/US07/82139, and PCT/US07/82134, all filed on Oct. 22, 2007, which are herein incorporated by reference in their entirety for all purposes.

A security apparatus according to an embodiment of the invention may comprise a head and a security device. The head and the security device may be physically and/or operationally coupled together.

The security device may comprise a cable, or some other type of device to provide security. If the security device comprises a cable, then the cable may be secured to an object other than the portable electronic device, such as an immovable object. The immovable object can comprise objects such as a desk or cabinet so that a portable electronic device coupled to the cable cannot be removed. In another embodiment, the security device may comprise a wireless device such as a wireless transmitter and/or receiver. The wireless device may be used in a proximity detection system or a motion detection system. For example, a motion detector could present in the wireless device so that when the motion detector moves, an associated alarm is triggered. The alarm may be in the security device or may be external to the security device. In another embodiment, there may be a base device associated with the wireless device, and these components may be used in a proximity detection system. Wireless signals may be transmitted between the security device and the base device, and when these devices are separated by a predetermined length, an associated alarm (e.g., an audible alarm) may be triggered. The alarm could be in the base device or in the security device.

The head may be a locking head. A locking head according to an embodiment of the invention may comprise a locking mechanism such as a key locking mechanism or a combination locking mechanism disposed within it.

The portable electronic device that is to be secured by the security apparatus may comprise any suitable device. Examples of such devices comprise portable computers, printers, flat panel televisions and monitors (small and large), projectors, external hard-drives, portable media devices, smartphones, etc., or any combination thereof.

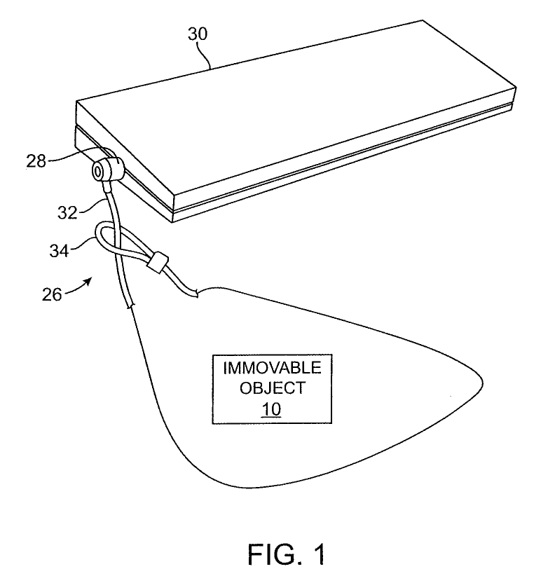

FIG. 1 shows a system comprising a portable electronic device 30 and a security apparatus 26 that is used to secure the portable electronic device 30 to an immovable object 10 such as a desk leg or the like. The security apparatus 26 comprises a head 28 and a security device, which may be a cable 32 in this example. The cable 32 is coupled to the head 28, which may be a locking head in this example. A loop 34 is at a terminal end of the cable 32. The cable 32 may comprise a strong material such as stainless steel or Kevlar™.

To secure the portable electronic device 30 to the immovable object, the cable 32 may be wrapped around the immovable object and the head 28 may pass through the loop 34. An engagement element in the head 28 may then be inserted into an aperture in the portable electronic device 30, or in an aperture (not shown) in a lock interface member that is associated with the portable electronic device 30. A stabilizing element may be inserted, concurrently with the engagement element, into the aperture in the lock interface member to stabilize the head 28 so that the engagement element cannot be readily withdrawn from the aperture. A locking mechanism such as a key locking mechanism or a combination locking mechanism may be used to keep the stabilizing element and/or the engagement element from moving or not moving. In other embodiments, the stabilizing element may first be inserted into the aperture in the lock interface member, and/or an aperture in the portable electronic device, and the engagement element may thereafter be inserted therein to engage the aperture in the portable electronic device or in the lock interface member. In a further embodiment, the engagement element may first be inserted into the aperture in the lock interface member and/or an aperture in the portable electronic device to engage the aperture, and the stabilizing element may thereafter be inserted in the portable electronic device or in the lock interface member.

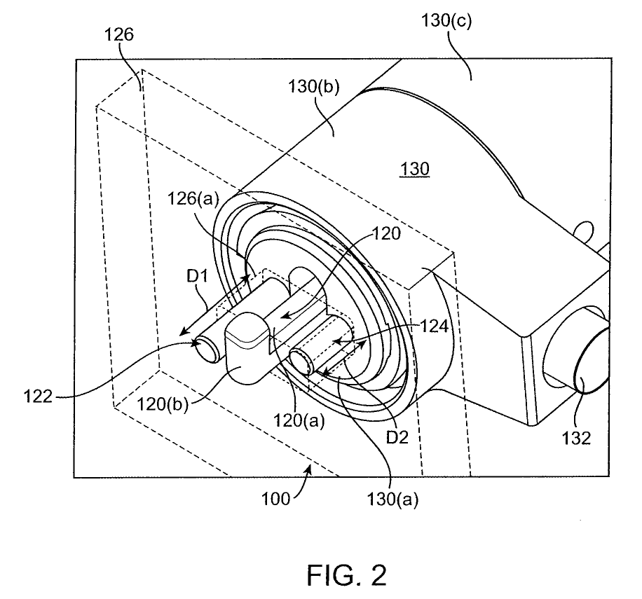

Specific security apparatus embodiments are shown in FIGS. 2-5.

FIG. 2 shows a security apparatus for use with an aperture 126(a) in a housing portion 126. The walls defining the aperture 126(a) and the housing portion are shown by dotted lines. The housing portion 126 may be a wall or part of the housing of a portable electronic device (not shown) or a portion of a lock interface member associated with the portable electronic device. It may comprise an aperture 126(a) which may be in the form of a slot that has sides with dimensions of about 3 mm by about 7 mm. Such small security slots do not significantly alter the aesthetic appearance of portable electronic devices, but can be used to deter theft. For example, if a thief tries to separate a lock device from a portable electronic device, the portable electronic device will be damaged, thereby impairing its value.

The security apparatus in FIG. 2 is in the “locked” position, such that it is engaged with a side of the aperture 126(a). The security apparatus includes a head 100 having a housing 130. In this example, the housing 130 comprises a number of different components including a front plate 130(a), a rear housing portion 130(c), and a cable ring 130(b) between the front plate 130(a) and the rear housing portion 130(c). A ferrule 132 extends from the cable ring 130(b), and can be attached to the previously described security device (e.g., a cable). In other embodiments, the housing 130 could be in the form of one integral structure, instead of being formed of multiple components. The housing 130, and any components of the housing 130, are preferably made of a hard material such as stainless steel.

Any suitable locking mechanism may be housed inside of the housing 130. Suitable locking mechanisms include conventional tumbler style locks, disk locks, etc.

An engagement element 120 extends from the housing 130. In this example, the engagement element 120 is in the form of an L-leg. The L-leg includes a first linear proximate portion 120(a), and a second linear distal portion 120(b), which is substantially perpendicular to the first linear proximate portion 120(a) (i.e., the first linear proximate portion 120(a) is approximately ninety degrees to the second linear distal portion 120(b)). Although the engagement element 120 is in the form of a ninety degree angled L-leg in FIG. 2, the engagement element 120 may have other shapes in other embodiments of the invention. For example, the distal portion of the engagement element 120 could be slightly curved in other embodiments and may perform the same function as the distal linear portion 120(b). In certain embodiments, the distal portion 120(b) may have a convex or concave shape, or may form an angle with the proximate portion 120(a) that is greater or less than ninety degrees. The engagement element 120 may be made of a hard material such as stainless steel. Referring to FIG. 2, the engagement element 120 is coupled with a single side of the aperture 126(a). The distal portion 120(b) is located within the housing (by means of aperture 126). In certain embodiments, the angle of the engagement member 120 within the housing (such that it is coupled with only a single side of the aperture), optionally combined with one or more of the stabilizing elements 122, 124 located with aperture 126(a), prevents rotation of the security apparatus relative to the aperture, such that it cannot be removed. In alternative embodiments, the engagement element 120 can function to squeeze the housing between distal portion 120(b) and front plate 130(a), maintaining the locked position.

The security apparatus may also include one or more stabilizing elements, which may have any suitable form. FIG. 2 shows an embodiment of a security apparatus with two stabilizing elements. As shown in FIG. 1, the first and second stabilizing elements 122, 124 are on opposite sides of the engagement element 120. The at least two stabilizing elements 122, 124 may also be made of a hard material such as stainless steel.

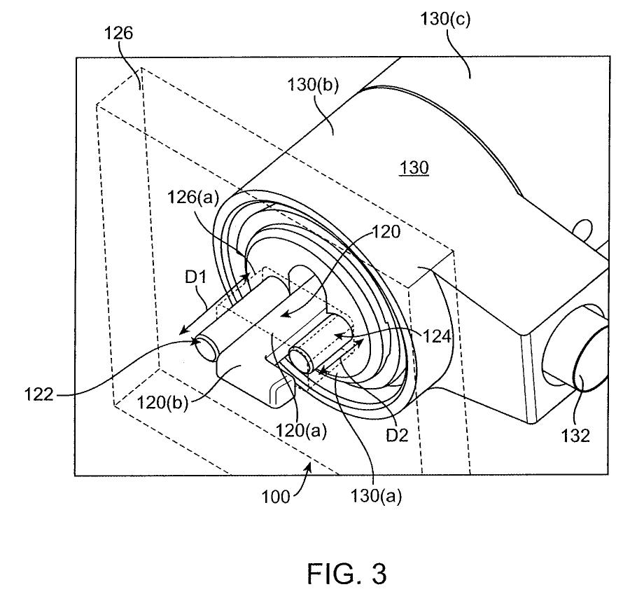

As shown in FIG. 2, a first stabilizing element 122 may be in the form of a pin, which extends from the housing 130 a length D1. A second stabilizing element 124, also in the form of a pin, may extend from the housing 130 a length D2. The first and second lengths D1 and D2 are different, and the first and second lengths D1 and D2 may differ by any suitable amount. For example, in some embodiments, the lengths D1 and D2 may differ by about the thickness of the distal portion 120(b) so that the distal portion 120(b) may lie over the end of the second stabilizing element 124 when the engagement element 120 is in the unlocked position (as shown in FIG. 3). Thus, the engagement element may also have a length of D1 measuring from the housing to the outside wall of distal portion 120(b) (e.g., the side of distal portion 120(b) further away from the housing 130(a)). Measuring from the housing 130(a) to the inside wall of distal portion 120(b) (e.g., the side of distal portion 120(b) closest to and facing the housing 130(a)), the length would be approximately D2. There may be small gaps or tolerances in the distances, to allow for engaging member 120 to rotate about stabilizing element 124 as will be described below. In other embodiments, the length D2 may be shorter than the length D1. For example, the length D2 may be about one-half of D1.

FIG. 3 shows a perspective view of an embodiment of a security apparatus in an “unlocked” configuration. In FIG. 3, like numerals as in FIG. 2 designate like elements, and the descriptions of like elements may not be repeated in all instances. In the locked configuration (as seen in FIG. 2), the distal end portion 120(b) of the engagement element 120 does not lie over the end of the second stabilizing element 124, so that the first and second stabilizing elements 122, 124 and the engagement element 120 cannot be withdrawn from the aperture 126(a). The first and second stabilizing elements 122, 124 that are on opposite sides of the engagement element 120 prevent one from rotating the previously described lock head out of the slot 126(a).

In contrast to FIG. 2, the unlocked configuration of FIG. 3 shows engagement element 120 rotated relative to the first and second stabilizing elements 122, 124. The distal end portion 120(b) of the engagement element lies over the end of the second stabilizing element 124 so that the first and second stabilizing elements 122, 124 and the engagement element 120 can be withdrawn from the aperture 126(a) or inserted into it. In this manner, the first stabilizing element 122, the engagement element 120, and the second stabilizing element form a single plane. This plane will have a length of D1. Furthermore, engagement element 120 and the first and second stabilizing elements 122, 124 can all have approximately the same height. This height is less than the height of the aperture 126(a). Thus, in embodiments where the height of aperture 126(a) is about 3 mm, the height of the engagement element 120 in the unlocked position and the first and second stabilizing elements 122, 124 can be slightly less than 3 mm, as is known in the art. This will allow for easy insertion of the device into aperture 126(a).

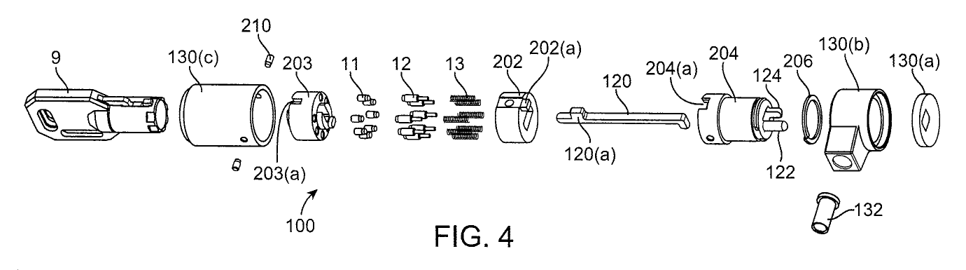

FIG. 4 shows an exploded view of a security apparatus 100, which is in the form of a radial lock according to an embodiment of the invention. The security apparatus 100 includes a cylinder shell 130(c) that is hollow and physically coupled to a cable ring 130(b). Cable ring 130(b) can physically couple to a security device such as a cable (not shown), as described above. Ferrule 132 is rotatably disposed within cable ring 130(b), and connects to the security device. This allows the security device to rotate relative to the head to allow for easy connection of the security device to an immovable object. O-ring 206 is disposed between cable ring 130(b) and pin assembly 204. Side pins 210 are inserted through apertures in cylinder shell 130(c) and through corresponding apertures in pin assembly 204, to lock the pin assembly 204 rotationally with respect to the cylinder shell 130(c). While pin assembly 204 is rotationally locked with respect to cylinder shell 130(c), both pin assembly 204 and cylinder shell 130(c) are rotatable with respect to cable ring 130(b). Two unequal length stabilizing elements 122, 124 are formed as part of the pin assembly 204. In certain embodiments, one or more stabilizing elements 122, 124 can be formed separately from pin assembly 204, and can be fixedly attached to pin assembly 204 such that the stabilizing elements 122, 124 do not move relative to other parts of pin assembly 204. An L-bar 120 is rotatably disposed within a passage in pin assembly 204. L-bar extends past the cable ring 130(b) to engage with an aperture in a portable electronic device (not shown) for locking. The distal end of L-bar 120 is an example of a slot engagement member. Spacer 130(a) can comprise a soft material such as plastic or rubber, to prevent any damage to the portable electronic device which is to be secured. L-bar 120 has a tab 120(a) at one end that aligns with a corresponding open region 203(a) (which can include a depression or a hole) in lower cylinder 203. This allows L-bar 120 and lower cylinder 203 to rotate together. Likewise, upper cylinder 202 includes a tab 202(a) that aligns with a corresponding open region 204(a) in pin assembly 204, allowing the upper cylinder 202 and pin assembly 204 to stay together.

Actual locking and unlocking action of the lock is brought about by the rotating motion of the lower cylinder 203, which in turn causes the L-bar 120 to move between a locked and unlocked position. In certain embodiments, such rotation can be approximately 90 degrees. Rotational movement of the lower cylinder 203 is normally effected by using an authorized tubular structure such as a key 9 that is adapted to fit into the opposing side of lower cylinder 203 and having a tab which aligns with a keyway (not shown) provided on the cylinder shell 130(c).

A series of angularly spaced combination pins 12 are slidably positioned within bores defined through the upper cylinder 202 and function to normally retain the lower cylinder 203 in its locked position wherein rotational motion is prohibited. The combination pins 12 is invariably urged toward lower cylinder 3 by means of coiled compression springs 13 disposed within the bores defined in the upper cylinder 202 which retain the combination pins 12. Under the urging of the springs 13, the combination pins 12 are disposed along the bores in such a manner that the outer ends of the pins normally project outward beyond the shear plane formed at the interface of the upper cylinder 202 and lower cylinder 203, and into corresponding bores defined through the lower cylinder 203. In this normal position, the combination pins 12 lock the lower cylinder 203 and the L-bar 120 against rotational motion relative to upper cylinder 202 and pin assembly 204, because at least some of the combination pins 12 lie across the shear plane.

Lower cylinder 203 is rotatably supported within the rear end of cylinder shell 130(c). A series of angularly spaced driver pins 11 are slidably positioned within bores defined in lower cylinder 203 and function to receive the key 9. Alignment of all pins at the shear plane (which is the junction between lower cylinder 203 and upper cylinder 202) displaces different driver pins 11 by different predetermined axial distances, due to the varying lengths of combination pins 12, when the driver pins 12 are pushed inward by a key or the like. For example, a properly coded key 9 can displace the driver pins 11 predetermined axial distances in order to cause the rear ends of all of the combinating pins (the driver pins 11 and the combination pins 12) to be simultaneously aligned at the shear plane so that the lower cylinder 203 may be rotated. In certain embodiments, combination pins 12 can be of approximately the same size as each other, and driver pins 11 can have varying lengths.

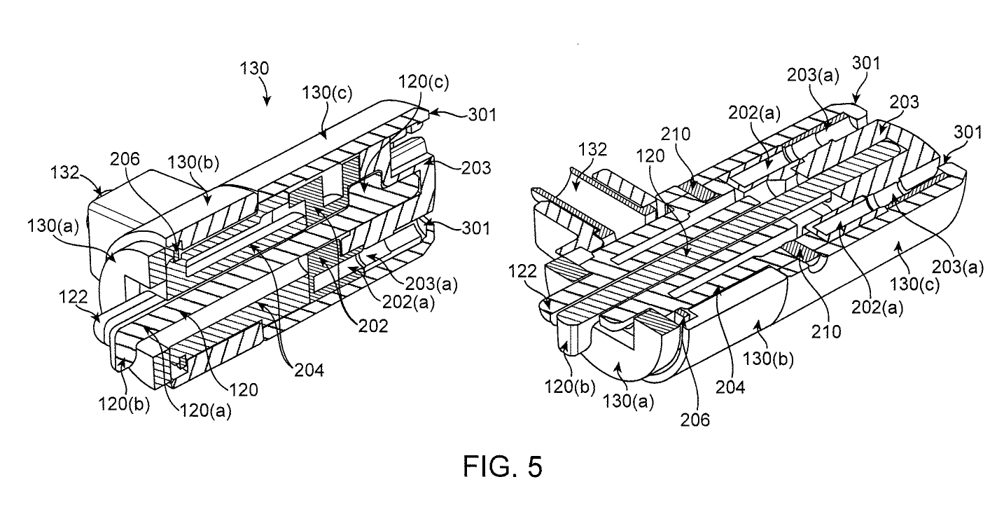

Referring to FIG. 5, two perpendicular cross-sectional views can be seen of a security apparatus according to an embodiment of the invention. The security apparatus of FIG. 5 is in the locked configuration, such that engagement element 120 is rotated relative to first stabilizing element 122. In the locked configuration, distal portion 120(b) protrudes out and is capable of engaging with a side of an aperture in a portable consumer device (not shown). In this example, the housing 130 comprises a number of different components including a front plate 130(a), a rear housing portion 130(c), and a cable ring 130(b) between the front plate 130(a) and the rear housing portion 130(c). O-ring 206 is located within housing 130, behind front plate 130(a). A ferrule 132 extends from the cable ring 130(b), and can be attached to the previously described security device (e.g., a cable). Within the housing 130 is a pin assembly 204, which is fixedly coupled to upper cylinder 202. Pin assembly 204 and upper cylinder 202 can be coupled to each other by any suitable means, such as overlapping tabs, screws, etc. Side pins 210 are inserted through apertures in rear housing portion 130(c) and through corresponding apertures in pin assembly 204, to lock the pin assembly 204 rotationally with respect to the rear housing portion 130(c).

Lower cylinder 203 is located inside rear housing portion 130(c) and held in place between upper cylinder 202 and the flange 301 formed on the end of rear housing portion 130(c). Lower cylinder 203 is capable of rotating relative to rear housing portion 130(c) and upper cylinder 202. Driver pins (not shown) can be located within bores 203(a) defined within lower cylinder 203. These driver pins can abut combination pins (not shown) that reside in bores 202(a) defined within upper cylinder 202. Thus, as described above, when the properly coded key is used, the driver pins and the combination pins will be adjacent to each other along the shear line created between lower cylinder 203 and upper cylinder 202. Thereafter, a rotation of the key will rotate lower cylinder 203 with respect to upper cylinder 202. Engagement element 120 is connected to lower cylinder 203 by means of protrusion 120(c), and will also rotate. This will allow for the locking and unlocking of the security apparatus.

Security apparatuses like the ones described above, can be configured and/or used in any suitable manner. In some embodiments, the security apparatus only has one fixed stabilizing element along with an L-shaped engagement member. The combined width of the engagement member and the stabilizing element is enough to prevent rotation within an aperture, such that the security apparatus is difficult to remove when in the locked state. In some embodiments, the engagement member can move (e.g., rotate) between a locked configuration and an unlocked configuration, while the first and second stabilizing elements remain in fixed positions. In other embodiments, the engagement member can remain stable and one or more stabilizing elements can extend into the aperture in the portable electronic device, after the engagement member is turned to a locked configuration (e.g., by rotating the entire head), to secure the security apparatus to the portable electronic device. To separate the security apparatus from the portable electronic device, the one or more stabilizing elements can be retracted. These embodiments can be used with a push button arrangement for moving the stabilizing elements. A suitable push button mechanism that can be used to cause movement of the stabilizing element(s) is in U.S. Pat. No. 6,591,642, which is herein incorporated by reference in its entirety.

Other embodiments are also possible. For example, in other embodiments, a combination mechanism can be used to cause the security apparatus to be in either a locked or unlocked configuration. The combination mechanism can comprise symbol selectors (dials with letters, numbers. etc.). Selecting the proper symbols can allow a user to lock or unlock the apparatus. In certain embodiments, the combination mechanism can interact with the engagement member or stabilizing elements to move one or both of them from a locked or unlocked position. In some implementations, the engagement element can extend and retract relative to the housing of the head of the security apparatus and/or relative to one or more stabilizing elements. In some implementations, the housing of the head of the security apparatus can be fixedly attached to one or more stabilizing elements, and can move relative to an engagement element. A suitable combination mechanism that can be used to lock or unlock embodiments of the security apparatus is in U.S. Pat. No. 6,513,350, which is herein incorporated by reference in its entirety.

Embodiments of the invention also include methods of use. Various method embodiments are apparent from the descriptions above. For example, one embodiment of the invention is directed to a method including inserting the first and second stabilizing elements concurrently with the engagement element into the aperture, and moving (e.g., rotating) the engagement element, thereby securing the security apparatus to the portable electronic device via the aperture. The stabilizing elements may be “fixed,” such that they do not move relative to the front plate of the security apparatus.

Another embodiment of the invention is directed to a method for using the above-described security apparatus with a portable electronic device comprising an aperture. The method comprises inserting the engagement element into the aperture, and moving (e.g., rotating or extending) at least one of the first and second stabilizing elements, thereby securing the security apparatus to the portable electronic device via the aperture.

Embodiments of the invention have a number of advantages. For example, using an engagement element such as an L-leg engagement element allows for easy engagement with a security aperture. With the mechanism in the “unlocked” configuration the L-leg is stored above the shorter of two fixed anti-rotation pins (or other stabilizing elements). The pins and leg form a single plane that has a height and width less than that of a security slot, which provides for easy placement. The pins and leg are simply inserted into the security slot, and a key turns approximately 90 degrees to rotate the L-leg a corresponding amount to lock the security apparatus. An L-leg shaped engagement member and a static stabilizing element uses less material than other shapes. This can lead to cost savings in production, and also reduces environmental waste.

Using a long fixed anti-rotation pin ensures that the head engages the security slot and is difficult to rotate free from the slot when in it is in the “locked” configuration. The long fixed anti-rotation pin can extend further into the security slot than a pin that resides under the engagement element while in the unlocked configuration. Having a long anti-rotation pin ensures that sufficient material is inside the security apparatus to prevent a potential theft by interfering with the security aperture when a torque is applied to the head of the security apparatus; it cannot simply be rotated free from the security aperture due to the long fixed anti-rotation pin interfering with the aperture itself. The L-leg shape of the engagement member allows for various lengths of the long anti-rotation pin, to maximize security. Furthermore, the use of a short fixed anti-rotation pin allows for the rotation of the engagement member without interference, while providing additional security.

Lastly, the use of the two unequal length anti-rotation pins and the L-leg engagement element ensures good security and compatibility with existing security apertures. The two unequal length anti-rotation pins can be straight, while the L-leg engagement element can be bent to form the L shape.

Any recitation of “a”, “an”, and “the” is intended to mean one or more unless specifically indicated to the contrary.

The terms and expressions which have been employed herein are used as terms of description and not of limitation, and there is no intention in the use of such terms and expressions of excluding equivalents of the features shown and described, it being recognized that various modifications are possible within the scope of the invention claimed.

Moreover, one or more features of one or more embodiments of the invention may be combined with one or more features of other embodiments of the invention without departing from the scope of the invention.

All patents, patent applications, publications, and descriptions mentioned above are herein incorporated by reference in their entirety for all purposes. None is admitted to be prior art.

What is claimed is:

1. A security apparatus for use with a portable electronic device comprising an aperture, the security apparatus comprising:
a head comprising a housing, an engagement element extending from the housing, a first stabilizing element extending from the housing, and a second stabilizing element extending from the housing, wherein the first stabilizing element extends out of the housing a first length and the second stabilizing element extends out of the housing a second length, wherein the first and second lengths are different; and
a security device coupled to the head.

2. The security apparatus of claim 1 wherein the engagement element is in the form of an L-leg.

3. The security apparatus of claim 1 wherein the second length is shorter than the first length.

4. The security apparatus of claim 1 wherein the first and second stabilizing elements are on opposite sides of the engagement element.

5. The security apparatus of claim 1 wherein the engagement element has a proximate portion and a distal portion substantially perpendicular to the proximate portion, wherein the distal portion is located over the second stabilizing element when the security apparatus is in an unlocked configuration.

6. A system comprising:
a portable electronic device comprising the aperture; and
the security apparatus of claim 1 secured to the portable electronic device via the aperture.

7. The system of claim 6 wherein the portable electronic device is a computer.

8. The system of claim 6 wherein the portable electronic device is a flat panel television set, a flat panel monitor, a projector, an external hard drive, or a printer.

9. The system of claim 6 wherein the security device is a cable.

10. A method of using the security apparatus of claim 1 comprising:
inserting the engagement element into the aperture; and
moving the engagement element, thereby securing the security apparatus to the portable electronic device via the aperture.

11. The method of claim 10 wherein moving the engagement element comprises rotating the engagement element a between a locked configuration and an unlocked configuration.

12. The method of claim 10, further comprising inserting at least one of the first and second stabilizing elements into the aperture, prior to the moving the engagement element.

13. The method of claim 12, wherein the engagement element is inserted into the aperture concurrently with the insertion of the at least one of the first and second stabilizing elements.

14. A method of using the security apparatus of claim 1 comprising:
inserting the engagement element into the aperture; and
moving at least one of the first and second stabilizing elements, thereby securing the security apparatus to the portable electronic device via the aperture.

15. A method of locking a portable consumer device comprising an aperture, comprising:
inserting an engagement element and a stabilizing element into the aperture, wherein the engagement element and the stabilizing element are coupled to the head of a security apparatus;
rotating the engagement element with respect to the stabilizing element, such that the engagement element couples with a single side of the aperture; and
coupling a security device to an object other than the portable consumer device, wherein the security device is attached to the head of the security apparatus.

16. The method of claim 15, wherein the engagement element comprises a distal portion and a proximate portion, wherein the distal portion is substantially perpendicular to the proximate portion.
